(19) United States
(12) Patent Application Publication
(10) Pub. No.: US 2005/0029437 A1
(43) Pub. Date: Feb. 10, 2005

(54) Capsule optical sensor

(76) Inventors: Akira Hasegawa, Tokyo (JP); Shinya Matsumoto, Machida-shi (JP)

Correspondence Address: Arnold International, P.O. Box 129, Great Falls, VA, 22066, US

(21) Appl. No.: 10/909,391

(22) Filed: Aug. 3, 2004

(30) Foreign Application Priority Data
Aug. 8, 2003 (JP) 2003-290080

(51) Int. Cl. H01J 5/16; H01J 40/14

(52) U.S. Cl. 250/226

(57) ABSTRACT

A capsule optical sensor includes an illuminator and a sensor. The illuminator has a light source that produces light in the wavelength range from 600 to 2000 nm and the sensor has a photoelectric detection element and a variable spectroscopic element in front of a light receiving surface of the photoelectric detection element that can separately detect emissions from different fluorescent labels. Alternatively, the sensor may have plural photoelectric detection elements and optical filters in front of light receiving surfaces of plural photoelectric detection elements, with the optical filters transmitting different wavelength bands so as to separately detect the emissions from different fluorescent labels. Also, the sensor may be a photoelectric detection element having a stack of light receiving layers, each for detecting a different fluorescent emission. In all cases, the sensor does not provide an imaging function, thereby minimizing the size of the capsule optical sensor.

This application claims benefit of foreign priority under 35 U.S.C. 119 from JP 2003-290080 filed Aug. 8, 2003, the contents of which are hereby incorporated by reference.

### BACKGROUND OF THE INVENTION

Recently, endoscopes have been extensively used in the medical and industrial fields. Endoscopes having the shape of a capsule that may be swallowed have been realized in the medical field, thereby eliminating the need to insert an insertion part as is required with conventional endoscopes. Such endoscopes have come to be known as ‘capsule endoscopes’, and the patient suffers less pain when swallowing the capsule endoscope as compared to the pain associated with inserting the insertion part of a conventional endoscope. For example, Japanese Laid-Open Patent Application No. 2001-95756 discloses a capsule endoscope that includes an objective lens and an illuminator formed of light emitting diodes that are symmetrically placed on opposite sides of the objective lens within a nearly semispherical transparent cover. A portion of a subject that is illuminated by the light emitting diodes within the observation range of the objective lens is imaged onto an image pickup array by the objective lens.

Conventional endoscopes have been used in diagnosis and treatment wherein a fluorescent substance that has an affinity to a lesion, such as cancer, has previously been administered to the patient and an excitation light that excites the fluorescent substance is applied so that fluorescence from the fluorescent substance that deposits at the lesion can be detected. For example, Japanese Laid-Open Patent Application No. H10-201707 describes a conventional endoscope wherein, when an indocyanine green derivative labeled antibody (which emits visual fluorescence when excited by infrared light and which has excellent transmittance) is introduced into the lesion, the lesion may be observed for fluorescence. The influence of self-fluorescence of living tissue is eliminated and thus the likelihood of overlooking lesions deep inside living tissue is reduced.

Indocyanine green derivative labeled antibody that is attached to human IgG as a fluorescent agent is excited by excitation light having a peak wavelength of approximately 770 nm, and it produces a fluorescence peak wavelength at approximately 810 nm. Based on this knowledge, the invention disclosed in Japanese Laid-Open Patent Application No. H10-201707 emits light having wavelengths in the approximate range of 770 nm-780 nm from a light source into a body and detects light having wavelengths in the approximate range of 810 nm-820 nm from the body so as to determine the presence of a lesion.

It is a well known fact that, as for cancer, the earlier it is found, the less physical burden the patient experiences during treatment (less invasion) and the more effective the treatment can be (improved survivability). Early detection of cancer is a major goal in the life science/medical fields. However, cancer cells in the earliest stage show only meager morphologic changes as compared to normal cells and, in reality, conventional techniques that focus on morphologic changes to determine the presence of cancer are not applicable. Furthermore, cancer in the earliest stage develops several millimeters below the surface of living tissue. In addition, living tissue scatters light sufficiently thus making it difficult to look through living tissue. These two factors make the problem of detecting cancer in the earliest stages very difficult, especially in view of the consideration that the object of interest forms part of a living body.

An attempt has been made to develop a technique that combines the use of infrared light that can reach deep inside living tissue without scattering the infrared light with a technology to introduce different fluorescent labels into plural different specific proteins that appear when cancer develops in living cells so as to enable cancer to be detected in the earliest stages. In addition, an attempt has been made to predict whether certain living tissue will become malignant. In addition to endoscopes, other medical apparatuses that may be used to diagnose cancer include CT, MRI, and PET. Each of these types of diagnostic apparatuses uses an external sensor to depict the human body three-dimensionally, and each is a non-invasive organ examination tool. Although apparatuses such as CT, MRI and PET can detect cancer that grows approximately one cm or larger, the resolution of these apparatuses is insufficient to detect cancer in the earliest stages. Thus, whether or not a mass of cells is likely to become malignant remains undiagnosed until later stages.

Conventional endoscope techniques, including capsule endoscope techniques, have not previously achieved the capability to separately detect plural peak emission wavelengths in the near-infrared range. Therefore, even if plural fluorescent labels are introduced into living tissue, conventional endoscopes cannot discern the different fluorescent emissions from the different fluorescent labels. Moreover, with the administration of conventional fluorescent agents, the fluorescent wavelengths produced span a broad band of wavelengths, and this is not useful for detecting cancer-specific proteins.

In a capsule endoscope, there is a need for miniaturizing the capsule in order to reduce the pain a patient suffers in swallowing the capsule. In addition, the problem mentioned in the paragraph above relating to the detection capabilities of plural fluorescent labels needs to be solved. FIG. 24 is an illustration that shows an example of how a conventional capsule endoscope is used. A conventional capsule endoscope 51 has a relatively large outer diameter Φ of 10 mm. Thus, it can be used only for examining lumen organs having relatively large open spaces, such as the esophagus 52, the stomach 53, and the large intestine 54. Thus, examination and diagnosis cannot be conducted for fine duct organs such as blood vessels and the pancreas. Furthermore, conventional capsule endoscopes use an image pickup array as described, for example, in Japanese Laid-Open Patent Application 2001-095756. Such an image pickup array has a large number of photoelectric detection elements that are arranged two-dimensionally so as to form an image pickup area. This hampers miniaturization.

FIG. 25 is an illustration to exemplify the information acquisition from a conventional capsule endoscope. A conventional capsule endoscope 51 is used to examine an object such as a stomach 53 having a large intra-luminal diameter. Hence, complex positional control is required of the capsule endoscope. For the purpose of obtaining images and knowing what is being viewed, not only is information needed concerning the location of the capsule endoscope, but also, directional information regarding the field of view is required. This complicates the structure of the capsule body and increases the power consumption, leading to a larger size capsule than is desired.

### BRIEF SUMMARY OF THE INVENTION

The present invention relates to a capsule optical sensor that is miniaturized and may be used to examine a patient who has been administered plural fluorescent labels that produce fluorescence in the near-infrared range. More specifically, the present invention provides a capsule optical sensor that is miniaturized and structured so as to detect plural, near-infrared fluorescent wavelengths produced by plural fluorescent labels introduced into living tissue.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is a schematic diagram that illustrates the entire structure of a capsule optical sensor 1 as well as a block diagram of an external unit 20 that may be used with the capsule optical sensor;

FIG. 2 is a block diagram of an embodiment of the capsule optical sensor 1 shown in FIG. 1;

FIG. 3 is a block diagram of an embodiment of the external unit 20 shown in FIG. 1;

FIG. 4 is an illustration that is used to explain the structure of a tunable filter, such as the tunable filter 6 shown in FIG. 1;

FIG. 5 shows the spectral transmittance of the tunable filter 6 shown in FIG. 1;

FIG. 6 is a cross section of an embodiment of a tunable filter 6 that may be used in the present invention;

FIG. 7 is a cross section of another embodiment of the tunable filter;

FIG. 8 shows the spectral reflectance of normal living tissue and the fluorescence as a function of wavelength of fluorescent labels (quantum dots);

FIG. 9 is a graphical representation that shows the spectral transmittance of the tunable filter (solid line) and the fluorescent emission spectrum from abnormal living tissue (broken line);

FIG. 10 shows the light emission intensity as a function of wavelength of excitation light of a light emitting element;

FIG. 11 shows the spectral transmittance of the fixed filter;

FIG. 12 is a graph of the fluorescence intensity versus wavelength of an abnormal subject;

FIG. 13 shows the spectral transmittance in a wavelength region from 950 nm to 2000 nm for one example of a two-layer type, tunable filter that may be used in the present invention;

FIG. 14 shows the spectral transmittance in a wavelength region from 950 nm to 2000 nm for one example of a three-layer type, tunable filter that may be used in the present invention, wherein the air gaps of the two Fabry-Perot cavities are the same at any one time;

FIGS. 15(a)-15(d) show the spectral transmittance in a wavelength region from 950 nm to 2000 nm for one example of a three-layer type, tunable filter that may be used in the present invention, wherein the air gaps of the two Fabry-Perot cavities are different at any one time;

FIG. 16 is a schematic illustration that shows the structure of another embodiment of the capsule optical sensor of the present invention;

FIG. 17(a) is a front view of a fixed filter 5a shown in FIG. 16, and FIG. 17(b) is a front view of the sensor array 7a shown in FIG. 16;

FIG. 18 shows spectroscopic properties of the fixed filter 5a shown in FIG. 17(a);

FIG. 19 is a schematic illustration that shows the structure of another embodiment of the capsule optical sensor of the present invention;

FIG. 20 is a cross section of the sensor (formed of photoelectric detection elements) shown as a component in FIG. 19 when viewed from a position to the side of the sensor;

FIG. 21 shows an example of images displayed on a monitor;

FIG. 22 is an illustration of the chemical structure of a quantum dot;

FIG. 23 shows the excitation light spectrum (broken line) and the emission spectra (solid lines) of quantum dots formed of CdSe and InP and having different particle sizes;

FIG. 24 shows an example of how a conventional capsule endoscope is used;

FIG. 25 shows an example of how information is obtained from a conventional capsule. endoscope; and

FIG. 26 shows an example of how the capsule optical sensor of the present invention may be used.

### DETAILED DESCRIPTION

A first capsule optical sensor according to the present invention is provided with at least one illuminator and a sensor. The first capsule optical sensor is characterized by the illuminator having a light source that produces light of an arbitrary, narrow wavelength band within the range from 600 to 2000 nm, and the sensor having a photoelectric detection element and a variable spectroscopic element provided in front of the light receiving surface of the photoelectric detection element.

A second capsule optical sensor according to the present invention is provided with at least one illuminator and a sensor. The second capsule optical sensor is characterized by: the illuminator having a light source that produces light of an arbitrary, narrow wavelength band within the wavelength range from 600 to 2000 nm; the sensor having plural photoelectric detection elements and optical filters that are respectively provided in front of the light receiving surfaces of the photoelectric detection elements; and by having the optical filters transmitting different wavelength bands.

A third capsule optical sensor according to the present invention is provided with at least one illuminator and a sensor. The third capsule optical sensor is characterized by: the illuminator having a light source that produces light of an arbitrary, narrow wavelength band within the wavelength range from 600 to 2000 nm; the sensor having a photoelectric detection element; and the photoelectric detection element being formed of a stack of light receiving layers, with each layer detecting a different wavelength region.

A fourth capsule optical sensor according to the present invention is intended to examine a subject who has been administered plural fluorescent labels that produce fluorescence of different wavelengths in the near-infrared range, and is characterized by: an illuminator for exciting the plural fluorescent labels; a variable spectroscopic element for selectively transmitting the fluorescence produced by the plural fluorescent labels; a photoelectric detection element for receiving the light transmitted through the variable spectroscopic element; and a transmitter for transmitting output signals of the photoelectric detection element to a receiver that is located outside the capsule.

A fifth capsule optical sensor of the present invention is intended to examine a subject who has been administered fluorescent labels producing fluorescence of different wavelengths in the near-infrared range, and is characterized by: an illuminator for exciting the fluorescent labels; an optical filter that transmits one of n different fluorescent lights produced by the fluorescent labels; a sensor consisting of n light receiving units, each consisting of a photoelectric detection element that receives the light transmitted through the optical filter so as to detect all the fluorescent lights; and a transmitter for transmitting output signals of the sensor to a receiver provided outside the capsule.

A sixth capsule optical sensor of the present invention is intended to examine a subject who has been administered a number n of different fluorescent labels that produce fluorescence of different wavelengths in the near-infrared range, and is characterized by: an illuminator for exciting the fluorescent labels; a photoelectric detection element consisting of a stack of a number n of light receiving layers, each being sensitive to fluorescence of a specific wavelength among the n different fluorescent lights produced by the fluorescent labels so as to detect all the produced fluorescent lights; and a transmitter for transmitting output signals of the photoelectric detection element to a receiver that is provided outside the capsule.

The first and second capsule optical sensors of the present invention control the variable spectroscopic element that functions as a transmission wavelength separation element to scan for the peak wavelengths of fluorescence produced by the fluorescent labels. Thus, the fluorescent wavelengths in the near-infrared wavelength range can be rapidly separated for observation.

The first and second capsule optical sensors of the present invention each has a variable transmittance in at least part of the wavelength range from 600 to 2000 nm. When a subject is illuminated by the illuminator, the voltage for driving the variable spectroscopic element is changed. Preferably, the voltage of the transmission wavelength separation element is changed a number of times (more specifically, from two to n times) for n different fluorescent labels. In this way, at least two fluorescent wavelengths can be separated for observation.

It is preferred that, in the first and second capsule optical sensors of the present invention, the transmission wavelength separation element satisfies the following Condition:
2≦i≦n Condition (1)
where
i is the separation factor, defined as the number of narrow bandwidth wavelength regions that can be separated for separate measurement, and
n is the number of different fluorescent labels to be detected.

The first and second capsule optical sensors of the present invention are characterized by the fact that the transmission wavelength separation element is a Fabry-Perot type etalon. Using such an etalon as a variable spectral transmittance element ensures that the fluorescent wavelengths produced by fluorescent labels are detected even if they have a narrow bandwidth, Gaussian distribution.

It is desirable that the transmission wavelength separation element be formed of an etalon structure having three or more aligned translucent members. The etalon structure having three or more aligned translucent members allows the separation of fluorescent emissions having two or more peak wavelengths.

In the third to sixth capsule optical sensors of the present invention, the transmission wavelength separation element separates fluorescent emissions without there being any controls, and thus the structure of the capsule optical sensor is quite simple.

In the first to sixth capsule optical sensors of the present invention, plural fluorescent wavelengths in the near-infrared wavelength range are separated and transmitted for detection. In addition to the detection of cancer in the earliest stage, the present invention enables types of cancer-specific proteins to be identified. This enables one to diagnose whether the tissue is likely to become malignant. By using wavelengths in the near-infrared wavelength range of 600 nm-2000 nm, the illuminating light can reach deep inside living tissue due to reduced scattering and absorption by the living tissue, thereby enabling the efficient diagnosis of cancer in a living body.

In the first to sixth capsule optical sensors of the present invention, a filter for cutting off excitation light from the illuminator is provided. In these capsule optical sensors, infrared components of the illuminator can be transmitted. Furthermore, in the first to sixth capsule optical sensors of the present invention, a collection element is provided in front of the photoelectric detection element, which allows efficient collection of fluorescence. It is desirable in the first to sixth capsule optical sensors of the present invention that the fluorescent labels be substances containing InAs nanocrystal.

The capsule optical sensor of the present invention has a significantly reduced number, from several tens photoelectric detection elements to a single photoelectric detection element. Thus, the photoelectric detection element serves as a sensor and does not perform an imaging function as performed by a conventional capsule endoscope. Therefore, the capsule has a reduced diameter as compared to such a conventional capsule endoscope, which makes it possible to use it within fine ducts of a patient such as in blood vessels and in the pancreas.

With a compact spectroscopic element that can separate emission spectra of plural fluorescent labels being provided in front of a photoelectric detection element, narrow bandwidth fluorescence emissions having different center wavelengths that are produced by the labels which attach to different cancer-specific proteins can be separated and detected, thus enabling the diagnosis of cancer in the earliest stage as well as the diagnosis of whether a mass of cells is benign or malignant.

The capsule optical sensor can be located within the body by externally tracing its movement within the duct of a subject organ or within a blood vessel. Because the capsule optical sensor of the present invention can be made small in size and weight, the capsule position can be easily controlled. Moreover, by the capsule having a reduced number of photoelectric detection elements, the amount of power used by the capsule is also reduced. As described above, the capsule optical sensor of the present invention is highly functional despite it being small in size and weight.

Research in the life sciences, such as genomics and proteomics, has revealed that cancer develops as a pre-cancerous lesion and gradually metastasizes and/or infiltrates into normal tissue. Cancer is a genetic disease and it is believed that a succession of genetic mutations results in malignancy. Gene defects result in the expression of specific abnormal proteins. A diagnosis of a mass of cells being malignant is appropriate only when specific proteins associated with cancers or genes that cause defects have been detected.

According to recent reports, tumors can be diagnosed as benign or malignant when several types of proteins that are specifically expressed in cancer cells are detected. The chance that a tumor is malignant increases dramatically if additional, specific types of proteins are detected. Theoretically, plural cancer-specific proteins in a living body could be labeled with different fluorescent wavelengths. Then, the fluorescent wavelengths could be detected to determine whether certain cancer-specific proteins are present in order to predict that a mass of cells will become malignant.

As described above, living tissue of a patient scatters light in a significantly intense manner so that it becomes difficult to see through layers of living tissue that may overlie a region of interest. However, living tissue rarely scatters or absorbs light in the near-infrared to infrared wavelength ranges. For this reason, these ranges of light are often used for lesion diagnosis techniques. Light of these wavelengths is used as excitation light for fluorescent labels so that the fluorescent labels that are distributed deep inside a living tissue will emit fluorescence light emissions that can then be detected in order to diagnose cancer in an early stage. Plural cancer-specific proteins are labeled with different fluorescent wavelengths in the near-infrared to infrared wavelength range, and the fluorescent wavelengths that are detected are used to determine the presence of cancer-specific proteins in cells that are several millimeters deep within a living body. It is desirable that the respective fluorescent labels have narrow fluorescent wavelength properties so that plural fluorescent labels can be introduced, thereby increasing the number of types of cancer-specific proteins that can be detected to improve the accuracy of a diagnosis.

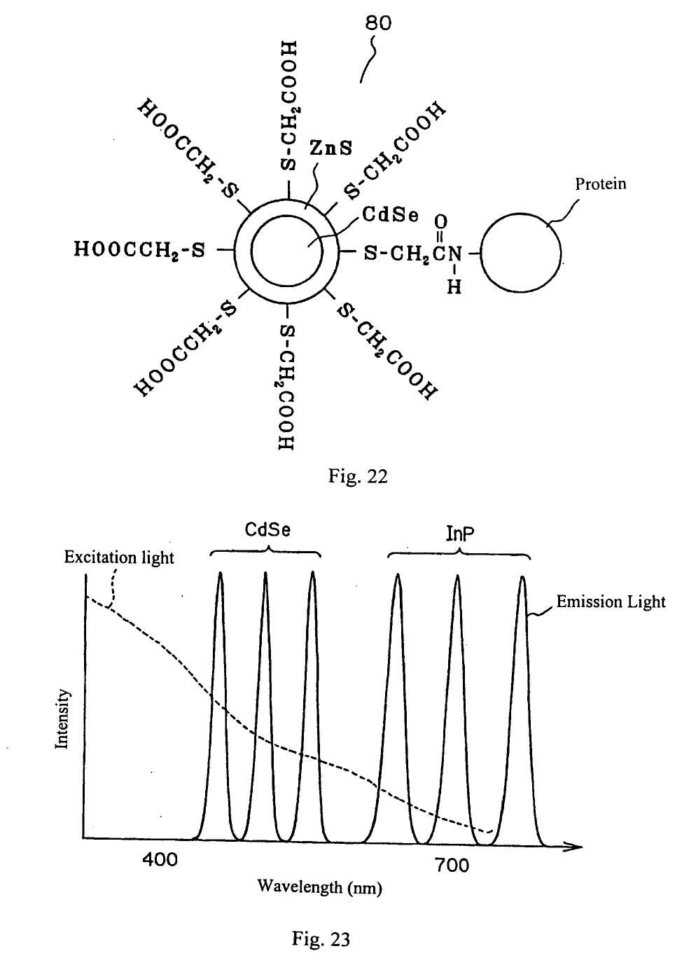

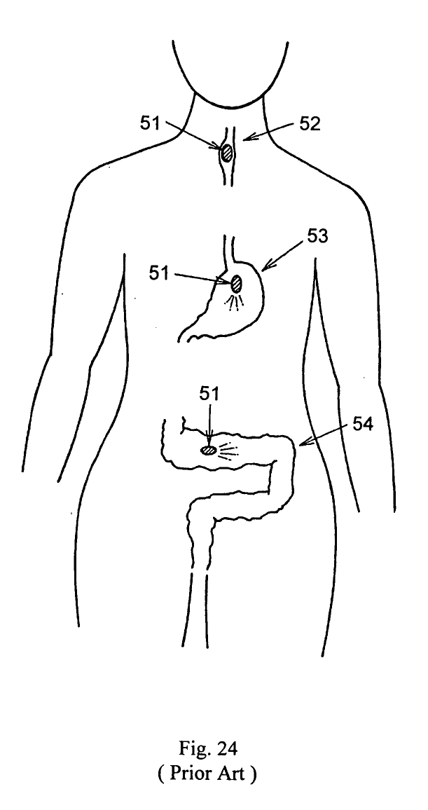

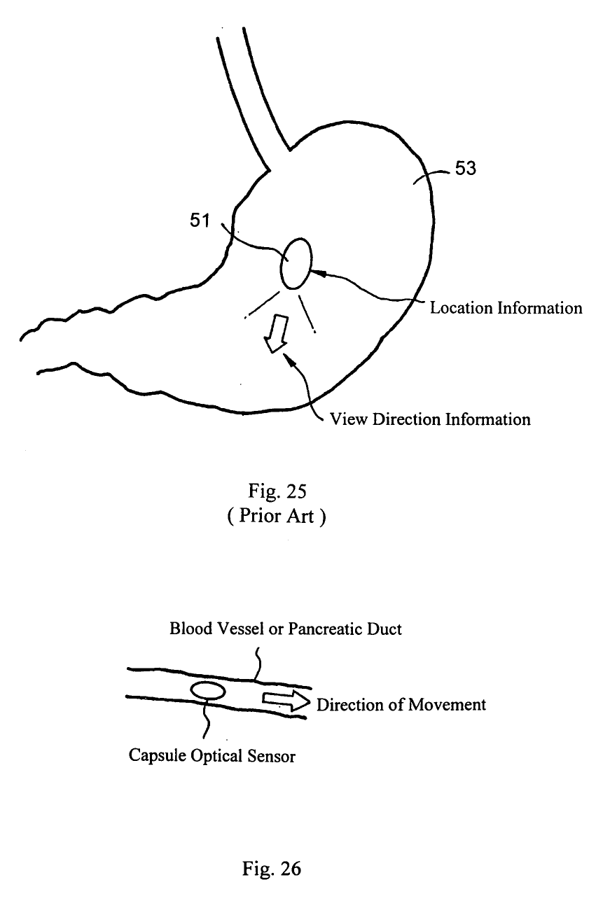

Quantum dots can be used as the fluorescent labels having narrow fluorescent wavelength properties described above. FIG. 22 is an illustration showing an example of a quantum dot. As illustrated in FIG. 22, a quantum dot 80 is formed of a micro-sphere of a semiconductor such as CdSe having a diameter of 2 to 5 nm as a nucleus. The nucleus is coated with ZnS to form a shell layer. Hydroxyl groups are then attached to the shell layer via a sulfur molecule. Parts of the hydroxyl groups are then bonded to the target proteins.

FIG. 23 shows the excitation light spectrum (broken line) and the emission spectra (solid lines) of quantum dots formed of CdSe and InP and having different particle sizes. As shown in FIG. 23, the excitation light distribution includes wavelengths as long as 700 nm. The quantum dots emit narrow bandwidth, fluorescent light of different peak intensities in the near-infrared wavelength range. Quantum dots have the following characteristic fluorescent wavelengths as compared with conventional fluorescent dyes.

(1) The half bandwidth of the emission spectrum of a quantum dot is approximately 1/200 of the center wavelength (typically 20 to 30 nm) of the emission spectrum, and is about one-third of that produced by a fluorescent dye.

(2) The peak wavelength of the emission spectrum of a quantum dot can selected in a flexible manner within the approximate range of 400 to 2000 nm, depending on the size (i.e., diameter) of the quantum dot and the materials from which the quantum dot is made. In other words, the material and diameter of quantum dots can be adjusted in order to create a narrow bandwidth, Gaussian distribution centered at a desired wavelength within the above-mentioned approximate range of 400 to 2000 nm.

(3) The excitation spectrum is more intense for shorter wavelengths within the visible to ultraviolet light range, regardless of the peak wavelength of the emission spectrum.

Quantum dots characteristically allow for a relatively flexible selection of plural fluorescent emission peak wavelengths depending on their particle sizes and materials, and have narrow bandwidth emission spectra. Thus, additional types of cancer-specific proteins can be identified within a given wavelength range as compared to when conventional fluorescent dyes are used due to their emission spectrums being more narrow in bandwidth. Hence, all quantum dots used can be effectively excited using a single wavelength band excitation light.

With the properties described above, quantum dots having known fluorescent emission wavelengths may be introduced into a living tissue as fluorescent labels (tags) and plural fluorescent wavelengths may then be separately detected to identify cancer-specific proteins corresponding to the fluorescent wavelengths. The quantum dots can be used as fluorescent labels to detect cancer in the earliest stage and even to determine whether an abnormal tissue condition, such as a tumor, within a patient is likely to be benign or malignant, as described above.

Several embodiments of the present invention will now be described.

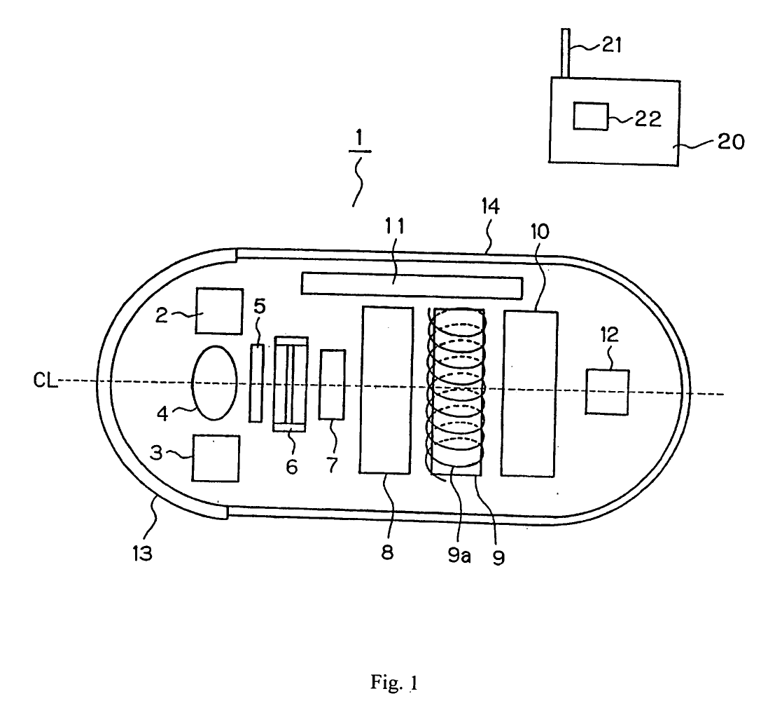

FIG. 1 shows the entire structure of a first capsule optical sensor 1 of the present invention as well as a block diagram of an external unit 20. In FIG. 1, a capsule optical sensor 1 is formed of: light emitting elements 2, 3; a lens that serves as a collection element 4 for collecting fluorescence from fluorescent labels attached to living tissue; a fixed filter 5; a tunable filter 6 (the variable spectroscopic element); and a photoelectric detection element 7 (i.e., a sensor). The lens 4 has an optical axis CL, and the light emitting elements 2 and 3 are symmetrically positioned about the optical axis CL.

The capsule optical sensor 1 further includes a control circuit 8, a power source 9 that is formed of a capacitor or a battery, a coil 9a that is electrically connected to the power source 9, a magnet 10, an antenna 11, and a transmitter 12. A transparent cover 13 transmits light that is emitted by the light emitting elements 2, 3 to illuminate an area of tissue in vivo and introduces the light reflected or scattered by the tissue into the lens 4. The capsule optical sensor 1 has a case 14. When the magnet 10 is magnetized by external magnetic field lines, magnetic induction causes electric current to flow in the coil 9a, and the power source 9, such as a capacitor or a battery, may thus be charged. The magnet 10 also serves as a means for moving the capsule optical sensor 1 using external electromagnetic waves. The transmitter 12 transmits detected signals of the sensor 7 via the antenna 11 to an external unit, and these transmissions can be used to determine the current position of the capsule optical sensor 1.

The external unit 20 includes a transmission/reception antenna 21, a monitor 22, and a control circuit (not illustrated). The transmission/reception antenna 21 receives signals from the antenna 11 and transmitter 12 of the capsule optical sensor 1. It also transmits electromagnetic waves or magnetic energy to the magnet 10. The monitor 22 displays location data and sensor detection data based on the detected signals of the sensor 7 that are transmitted via the antenna 11.

The light emitting elements 2, 3 emit light including wavelengths in the wavelength band of 600-2000 nm so as to illuminate living tissue of a subject who has been administered fluorescent labels. The light emitting elements 2, 3 have an output that includes excitation wavelengths of the fluorescent labels consisting of quantum dots, the chemical structure of which is shown in FIG. 22. Because the emitted visible and infrared light in the wavelength range of 600-2000 nm is only slightly scattered or absorbed, it can reach deep within living tissue. Therefore, this wavelength range can be used as excitation light for causing fluorescent emissions by quantum dots that can be used to diagnose a lesion that is developing deep within a living tissue.

The fixed filter 5 serves as an excitation light cut-off filter and has a spectral transmittance such that only infrared fluorescence produced by fluorescent labels is transmitted. More particularly, the fixed filter 5 transmits wavelengths in the infrared range that are longer than the wavelength of the excitation light in the infrared range, and the transmission range includes the fluorescence emission wavelengths of the fluorescent labels that have been administered to the living tissue.

The tunable filter 6 is an etalon-type, band pass filter having a variable wavelength transmittance property. The tunable filter serves to separate and transmit emitted fluorescent light from the fluorescent labels according to the wavelength of the light, the details of which will be described later. Unlike sensors in prior art capsule endoscopes, the sensor 7 may be formed of a single photoelectric detection element, and therefore is much smaller and does not require as much power to operate as in prior art capsule endoscopes. The sensor 7 detects the signals from the fluorescent labels in the respective wavelength ranges that are transmitted by the tunable filter 6.

The sensor 7 of the present invention is not intended to form images, but to simply detect the fluorescent light that would correspond to a single pixel of a prior art capsule endoscope sensor that is formed of an array of detectors arranged two-dimensionally. Thus, only a single photoelectric detection element is provided. When a CCD is used as a photoelectric detection element in a conventional capsule endoscope, several hundreds of thousands of pixels are used that capture an image. The present invention is different from a conventional capsule endoscope sensor in that as few as from several tens to one photoelectric conversion element may be provided, which allows dramatic down-sizing of the capsule optical sensor of the present invention, as well as of the capsule itself.

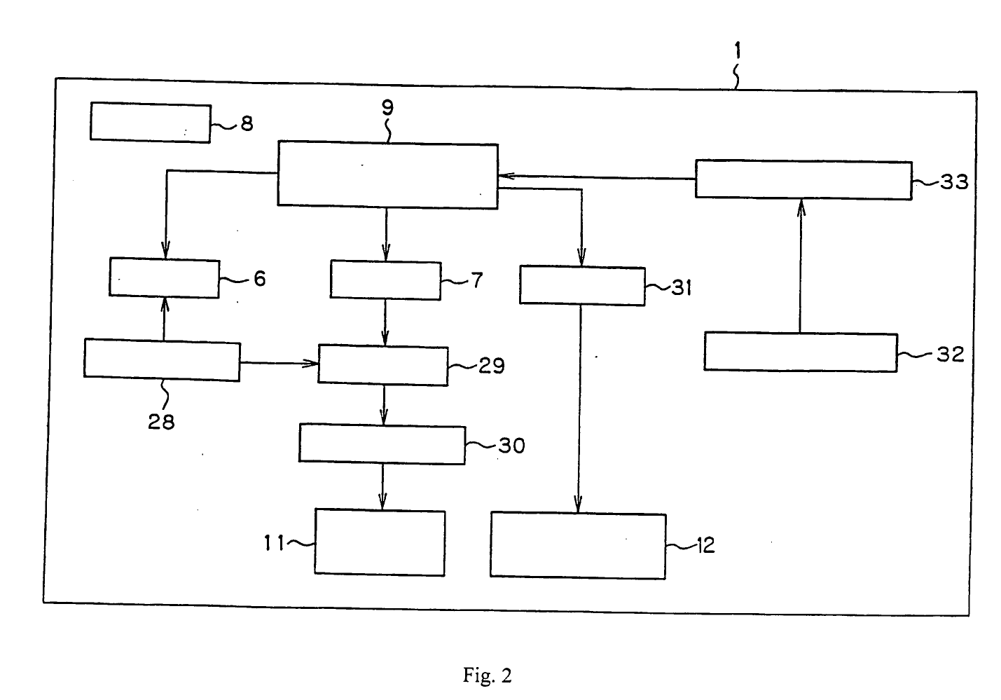

FIG. 2 is a block diagram that shows an embodiment of the internal structure of the capsule optical sensor 1 of FIG. 1 in more detail. The capsule optical sensor of the present invention may, in some cases, be better termed simply a ‘capsule sensor’. For those components that are identical in this embodiment to the embodiment shown in FIG. 1, the same reference numerals have been used in FIG. 2 as in FIG. 1. Referring to FIG. 2, the transmittance property of the tunable filter 6 is changed by controlling the voltage applied to a piezoelectric element. This in turn, controls the spacing between the translucent members that are positioned parallel to one another, with air being between the adjacent translucent members. In order to change the transmittance property of the tunable filter 6, a filter control circuit 28 is used to control the voltage from the power source 9 that is applied to the tunable filter 6, thereby changing the spacing between the translucent members. Of course, the means for controlling the tunable filter is not restricted to a piezoelectric element, as other means for controlling the tunable filter can be used. These include: an element that changes the spacing between the adjacent translucent members using a magnetic field, an element that uses electrostatic attraction to change the spacing between the adjacent translucent members, an element that uses a Micro Electro Mechanical Systems (MEMS) technique for this purpose, or other means that accomplish this result.

The detected signals of the sensor 7 may be supplied to a pre-processor circuit 29. The pre-processor circuit 29 is also controlled by the filter control circuit 28. In the pre-processor circuit, the detected signals of the sensor 7 can be amplified a selected amount by an amplifier that has an adjustable gain. The signals that are output from the pre-processor circuit 29 may be supplied to an A/D converter 30 that converts the analog signals into digital signals. The digital signals may then be transmitted to the external unit 20 via the antenna 11 as sensor signals. The voltage of the power source 9 is supplied to the coil 31 of the transmitter 12 so that the digital signals can be transmitted from the transmitter 12 to the external unit 20 via the antenna 11. An energy receiver 32 (the magnet 10 in FIG. 1) receives electromagnetic waves from the external unit and an energy transforming circuit 33 (the coil 9a in FIG. 1) is subject to electromagnetic induction for magnetic-electric transformation, which supplies electric current to the power source 9. In this manner both the digital signals and the present location of the capsule optical sensor can be determined.

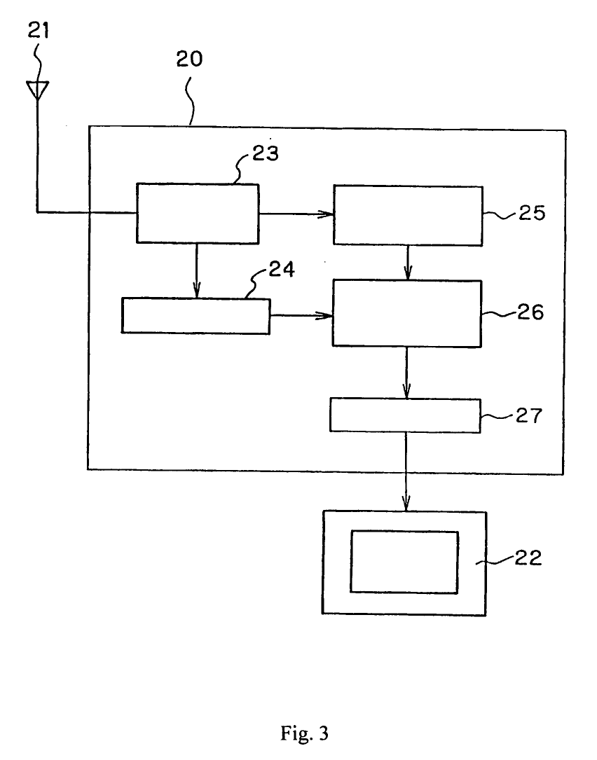

FIG. 3 is a block diagram that shows an embodiment of the external unit 20. Signals received at the antenna 21 are separated by the transmission-reception circuit (separation circuit) 23. The location detection signals are processed by a location detection circuit 24. The sensor signals are processed by a sensor signals processing circuit 25. The signals processed by the location detection circuit 24 and the signals processed by the sensor signals processing circuit 25 are supplied to a three-dimensional image forming circuit 26.

The three-dimensional image forming circuit 26 first creates a matrix regarding the location and fluorescent labels, as shown in Table 1 below, based on the information from the location detection circuit 24 and the sensor signals processing circuit 25. Table 1 shows the location information Sa (X1, Y1, Z1) and Sb (X2, Y2, Z2) when signals of five fluorescent labels are detected.

TABLE 1

| | fluo- | fluo- | fluo- | fluo- | fluo- |
|---|---|---|---|---|---|
| | rescent | rescent | rescent | rescent | rescent |
| | label 1 | label 2 | label 3 | label 4 | label 5 |
| Sa (X1, Y1, Z1): | ∘ | | ∘ | ∘ | ∘ |
| Sb (X2, Y2, Z2): | | ∘ | ∘ | | |

The location and morphology information of the living organ previously obtained from X-ray and CT is combined with the matrix information obtained from the capsule sensor (Table 1). Consequently, the location where fluorescence is detected is obtained. The digital signals from the three-dimensional image forming circuit 26 are supplied to a D/A transformer 27 where they are transformed into analog signals. The analog signals are supplied to an image display monitor 22 to display the location(s) where fluorescence has been detected while simultaneously displaying an image of the organ obtained from a different source such as from an X-ray or a CT apparatus.

The fluorescence emission peak wavelengths are calculated or counted and pseudo-colors can be displayed on a monitor (the monitor 22) depending on the counts. The location information on where cancer in the earliest stage has developed in the body combined with the information for identifying the distribution and types of cancer-specific proteins using the pseudo-color display depending on the counts of fluorescent wavelengths enables the accurate prediction of the lesion condition, whether benign or malignant, and the stage of development of the cancer.

The filter control circuit 28 (shown in FIG. 2) controls the variable transmittance feature as described above, calculates or counts the fluorescence peak emission wavelengths, refers to a reference table of fluorescent peak emission wavelengths versus cancer-specific proteins contained in a memory (not shown) so as to identify the types of proteins expressed in the living tissue, and stores the identified proteins in the memory as data. The stored data is read from the memory as needed and compared to the reference table of fluorescent peak wavelengths to cancer-specific proteins for diagnosis.

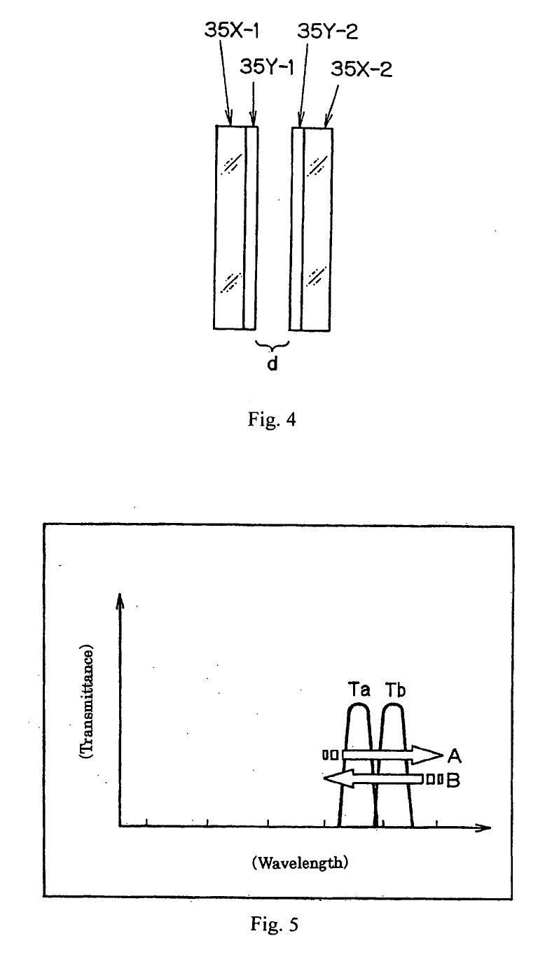

FIGS. 4 and 5 are schematic diagrams to explain the tunable filter. FIG. 4 is an illustration to explain the construction of the tunable filter and FIG. 5 is a graphical representation of the transmittance property thereof. As shown in FIG. 4, the tunable filter comprises two substrates 35X-1 and 35X-2, on the facing surfaces of which translucent films 35Y-1 and 35Y-2 are formed with air gap d in between. Light entering the substrate 35X-1 is subject to multiple beam interference. The air gap d is controlled to modify the wavelength of the maximum transmittance emerging from the substrate 35X-2. In other words, when the air gap d is changed, the wavelength of the maximum transmittance is changed from the wavelength corresponding to transmittance Ta to the transmittance Tb, and vice versa, as shown in FIG. 5. The air gap can be changed using, for example, a piezoelectric element. The tunable filter can be constructed using the translucent films 35Y-1 and 35Y-2. Here, the translucent film is one that has a high reflectance (low transmittance) over a wavelength range that includes the near-infrared region.

In this way, the tunable filter can be used to separate the fluorescent wavelengths of the fluorescent labels and detect specific wavelength bands. In such a case, the space between the substrates of the tunable filter is controlled to scan the peak wavelengths so that plural fluorescent wavelengths in the near-infrared region are detected.

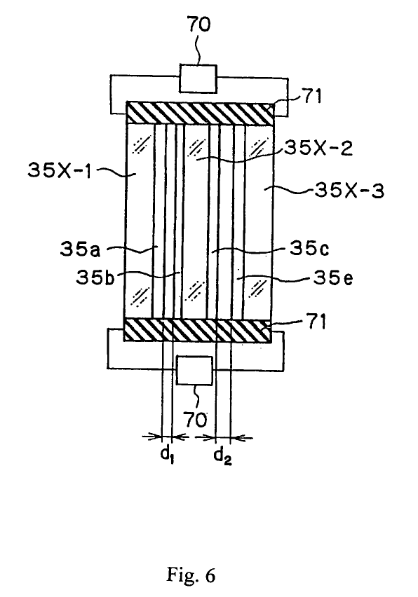

An embodiment of the three-layer tunable filter will now be described. FIG. 6 is a cross section of a tunable filter. In FIG. 6, substrates 35X-1, 35X-2, and 35X-3 are made of glass. Translucent membranes 35a, 35b, 35c, and 35e consist of laminated metal membranes such as silver, or several to several tens of laminated dielectric membranes. The figure further shows air gaps d₁ and d₂ and a cylindrical laminated piezoelectric actuator element 71 that is fixed to the periphery of the glass substrates 35X-1 to 35X-3 and the translucent membranes 35a, 35b, 35c, and 35e.

A variable voltage source 70 applies voltage to the laminated piezoelectric actuator element 71. The laminated piezoelectric actuator element 71 expands or contracts in the horizontal direction (the axial direction) of FIG. 6 in inverse proportion to the applied voltage. The actuator element 71 can control the air gaps d₁ and d₂ independently. An excitation light cut-off coating as shown in FIG. 11 can be applied to the substrate 35X-1 on the opposite surface to the translucent membrane 35a to eliminate the fixed filter for further down-sizing.

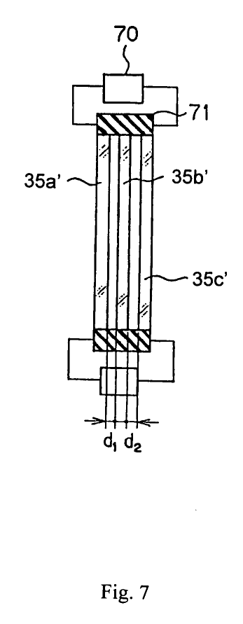

FIG. 7 also shows an embodiment of the three-layer tunable filter. In this filter, the substrates are eliminated and translucent films 35a′, 35b′, and 35c′ are provided. The movable parts are reduced in weight, thus reducing the load of the air gap control device such as the piezoelectric element. This contributes to higher response speeds and power savings. The etalon, consisting of plural layers, can be constructed by using substrates and translucent films or by using only translucent films.

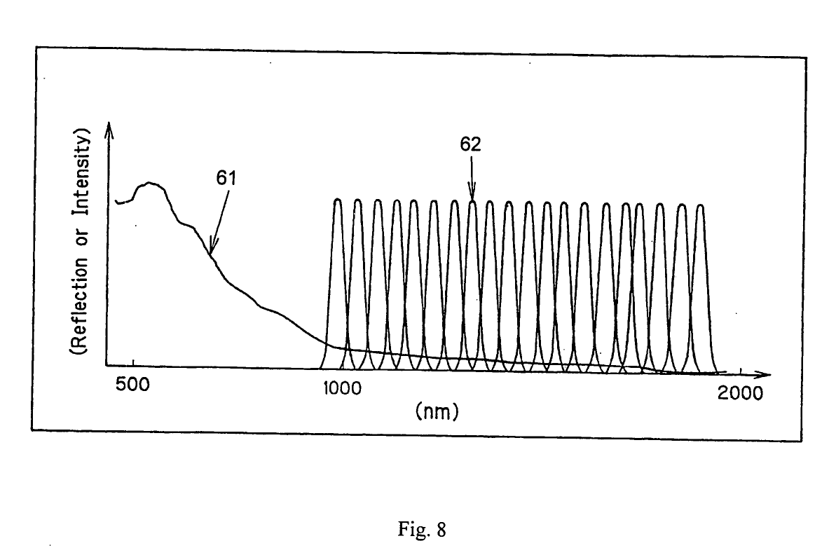

FIG. 8 shows the spectral reflectance 61 (i.e., the reflection (in arbitrary units) versus wavelength (in nm) of normal living tissue) and the fluorescence spectrum 62 (intensity in arbitrary units, versus wavelength, in nm) emitted by 20 fluorescent labels (quantum dots). The fluorescence spectrum is representative of the case when 20 different fluorescent labels are used. The 20 different fluorescent labels are different in material and particle size so as to emit fluorescent light having different peak wavelengths. These emission properties of the 20 different fluorescent labels have previously been stored in a memory of the external unit. Thus, the fluorescence intensity properties of the fluorescent labels (quantum dots) are known before they are administered to the living body.

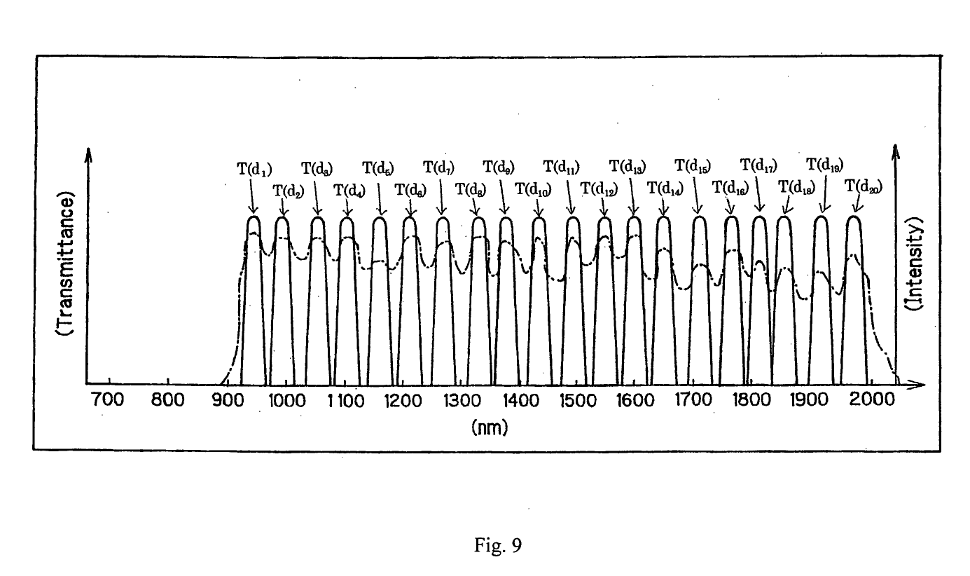

FIG. 9 is a graphical representation to show the spectral transmittance of the combination of the tunable filter and the fixed filter (the solid line), and the spectral intensity of the fluorescence emitted from abnormal living tissue (the dotted line). Among the vertical axes, the first vertical axis (on the left) indicates the transmittance and the second vertical axis (on the right) indicates the intensity, mentioned above, in arbitrary units. The horizontal axis indicates wavelengths in nm. T(d₁), T(d₂), . . . , T(d₂₀) are the transmittances when a two-layer type tunable filter is used and the gap thereof is sequentially set at d₁, d₂, . . . , d₂₀, respectively. Thus, by changing the width of the gap, the wavelength corresponding to the transmittance peak can be sequentially scanned.

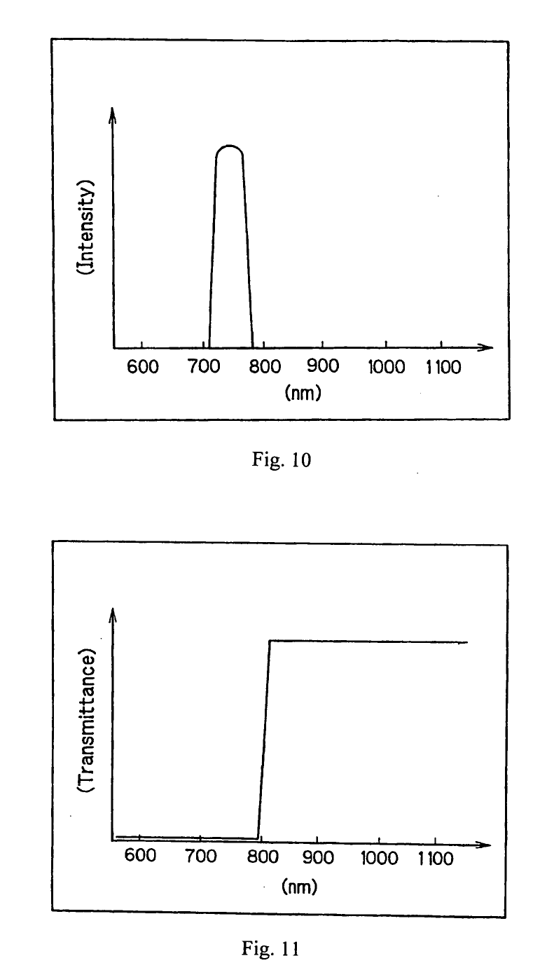

FIG. 10 is a graphical representation to show the spectroscopic property of the excitation light from the light emitting elements 2 and 3. FIG. 11 is a graphical representation to show the spectroscopic property of the fixed filter 5. As shown in FIGS. 10 and 11, the fixed filter 5 characteristically eliminates the excitation light components that emerge from the light emitting elements 2 and 3 and transmits the fluorescent components in the infrared range that are longer in wavelength than the excitation light. It is preferable that the excitation light blocking filter 5 has a blocking level of OD4 or higher. Here, “OD” means an optical density and is defined as log₁₀ (I/I′) assuming that I and I′ are the intensities of light entering and exiting the filter. The fixed filter 5 is preferably placed on the object side of the tunable filter. This allows one to eliminate the detection noise due to the auto-fluorescence generated by the tunable filter when it is irradiated by the excitation light. The excitation light blocking function may instead be performed solely by the tunable filter, enabling the number of filters to be reduced by omitting the fixed filter 5. This is helpful in miniaturizing the capsule optical sensor but is less effective in terms of eliminating the detection noise due to the auto-fluorescence generated by the tunable filter when it is irradiated by the excitation light.

Referring once again to FIG. 10, when the excitation light has the property as shown in this figure, since the fixed filter (FIG. 11) blocks the excitation light, only the fluorescence can be detected, as shown in FIG. 9. Therefore, as shown in FIGS. 8 and 9, by separating the emitted fluorescent lights using filters and by detecting plural light emission peaks thereof, abnormality of the living tissue can be detected.

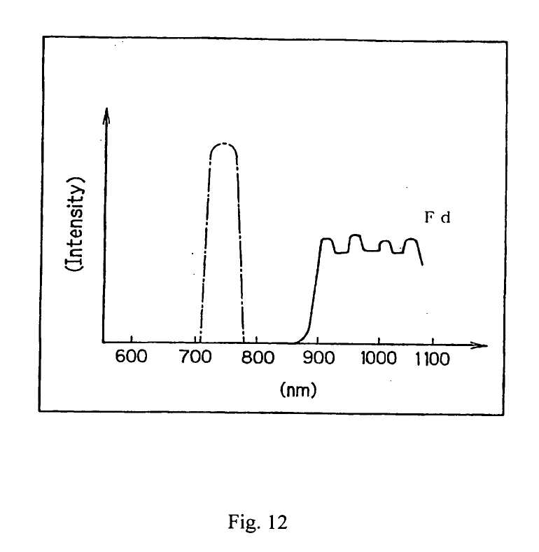

FIG. 12 shows the spectral intensity of the excitation light (the broken line) and the fluorescent emission spectrum Fd from abnormal living tissue (the solid line) when different quantum dots are bound to plural cancer-specific proteins. The excitation light, which has wavelengths in the infrared range, can reach deep into sub-mucosal regions under the surface of living tissue. Excited by one excitation wavelength, plural fluorescent labels emit fluorescence in random directions at different peak wavelengths from lesions that develop deep inside the living tissue. Consequently, the fluorescence transmitted through the living tissue may be separated into plural fluorescent wavelengths by the tunable filter for detection.

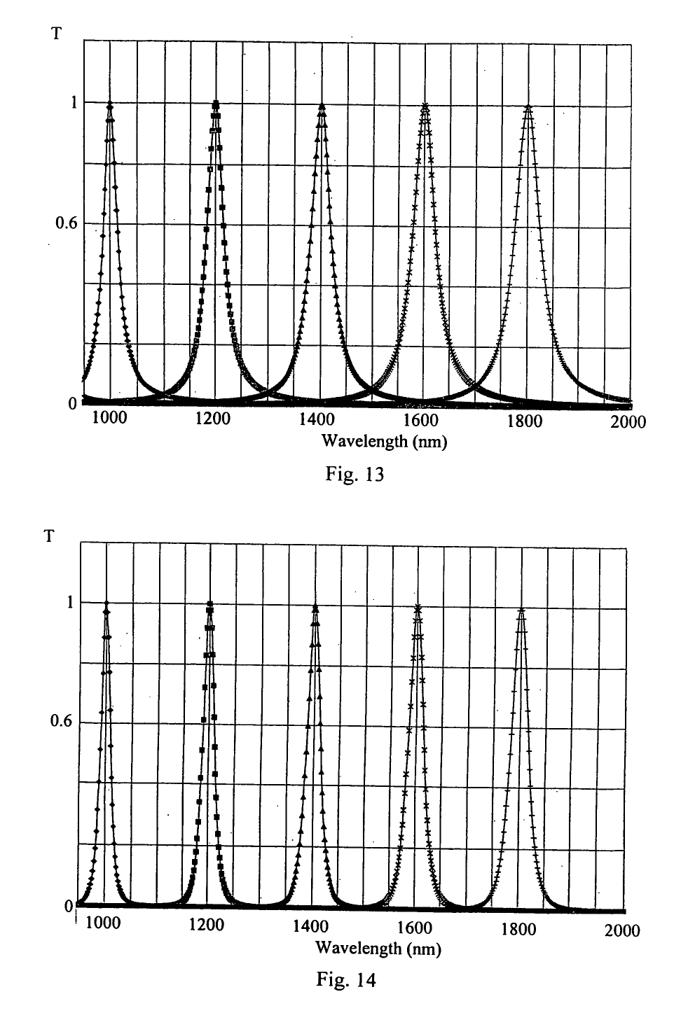

FIG. 13 shows the spectral transmittance for one example of a two-layer type, tunable filter over the wavelength range from 950 nm to 2000 nm, as the spacing d between the two layers is stepped from 500 nm to 900 nm in 100 nm increments. In other words, the transmittance curve having a peak transmittance at 1000 nm occurs when the spacing d between the two layers is 500 nm, the transmittance curve having a peak transmittance at 1200 nm occurs when the spacing d between the two layers is 600 nm, the transmittance curve having a peak transmittance at 1400 nm occurs when the spacing d between the two layers is 700 nm, the transmittance curve having a peak transmittance at 1600 nm occurs when the spacing d between the two layers is 800 nm, and the transmittance curve having a peak transmittance at 1800 nm occurs when the spacing d between the two layers is 900 nm. In the figure, the vertical axis indicates the transmittance of the tunable filter and the horizontal axis indicates wavelength. The reflectance of the translucent films (shown as 35Y-1 and 35Y-2 in FIG. 4) are 99% and the angle of incidence of the main light beam is 0 (zero) degrees. Thus, by changing the width of the gap “d”, wavelength corresponding to the transmittance peak can be sequentially scanned in the applicable wavelength range in the infrared region.

FIG. 14 shows the spectral transmittance for one example of a three-layer type, tunable filter over the wavelength range from 950 nm to 2000 nm, as the spacings d₁=d₂ between the two layers are stepped from 500 nm to 900 nm in 100 nm increments. In this figure as well, the vertical axis indicates transmittance of the tunable filter and the horizontal axis indicates wavelength. In FIG. 14, the reflectance of each of the translucent films (shown as 35a, 35b, 35c, 35d, and 35e in FIG. 6) is set at 99% and the two air gaps are changed while satisfying the relationship d₁ equals d₂ at any given time. Thus, the transmittance of the tunable filter shown in FIG. 14 for a given air gap spacing is actually the square of the transmittance shown in FIG. 13 for the same air gap spacing, since there are two Fabry-Perot cavities in a three-layer type, tunable filter as shown in FIG. 14, versus a single Fabry-Perot cavity in a two-layer type, tunable filter as shown in FIG. 13. Thus, a three-layer type, tunable filter has improved wavelength resolution in that the bandwidth of the transmitted wave bands is more narrow than for a similarly constructed two-layer type, tunable filter.

As is apparent from comparing the transmission curves shown in FIG. 14 versus those shown in FIG. 13, the resolution in terms of wavelength is determined by the reflectance of the translucent films and the width of the gap. Therefore, in the case where the reflectance of the translucent film is difficult to be made sufficiently high, it is desirable to use a three-layer type, tunable filter since the transmittance bandwidth of the tunable filter become more narrow, thereby increasing the resolution in terms of wavelength.

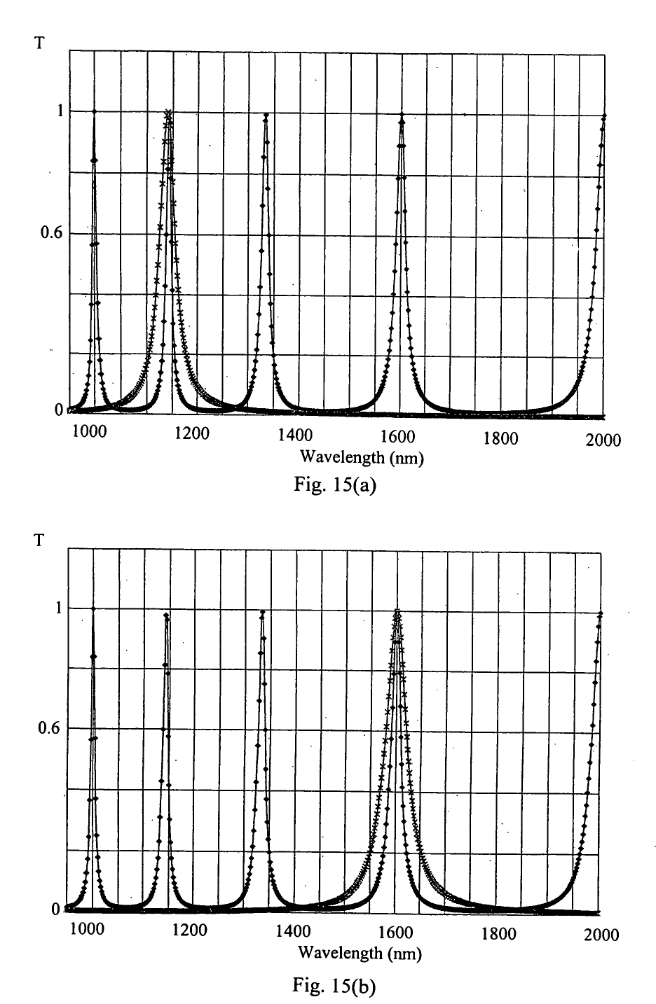

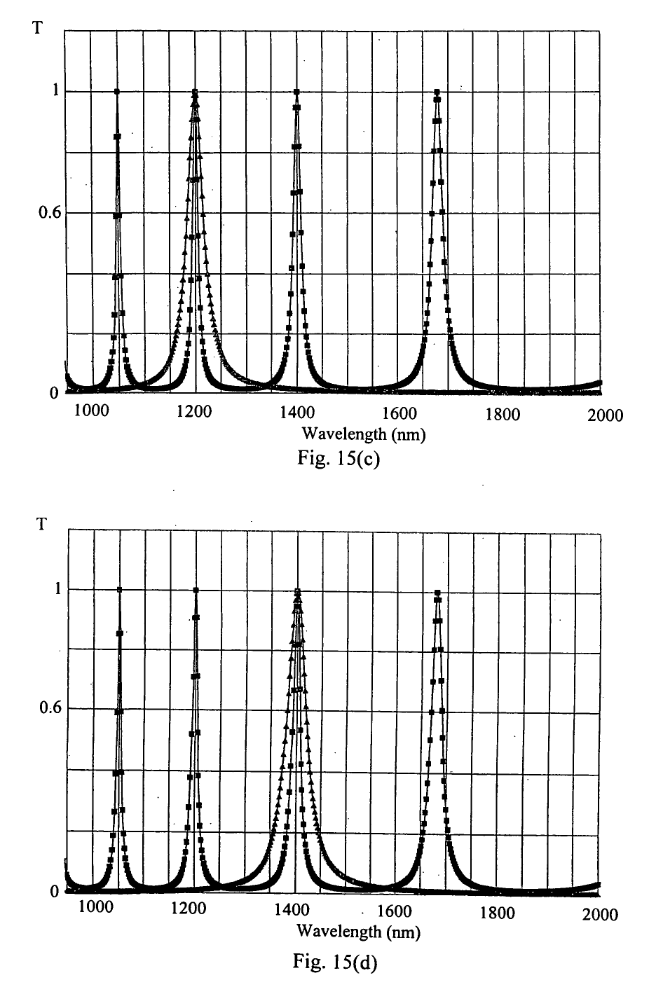

FIGS. 15(a)-15(d) show spectral transmittances of another example of a three-layer type, tunable filter. Once again, the vertical axis in each figure indicates transmittance of the tunable filter and the horizontal axis indicates wavelength. In the three-layer type, tunable filter shown in FIGS. 15(a)-15(d), the two air gaps d₁ and d₂ are different at a given time. The lines with small crosses or small triangles indicate the spectral transmittance given by the gap d1 and the lines with small rhombuses or small squares indicate the spectral transmittance given by the gap d2. Table 2 below lists the amount of the air gaps (in nm), as well as the wavelength of the transmission peak for each of FIGS. 15(a)-15(d).

TABLE 2

| | FIG. 15(a) | FIG. 15(b) | FIG. 15(c) | FIG. 15(d) |
|---|---|---|---|---|
| d₁ (nm): | 4000 | 4000 | 4200 | 4200 |
| d₂ (nm): | 570 | 800 | 600 | 700 |
| wavelength of | 1140 | 1600 | 1200 | 1400 |
| the trans- | | | | |
| mission peak: | | | | |

In this example, the reflectance of each of the translucent films shown as 35a and 35b in FIG. 6 is 95% and the reflectance of each of the translucent films shown as 35c and 35e in FIG. 6 is 99%. As is apparent from Table 2, the two air gaps are changed while satisfying the relationship that d₁ not equal d₂. This tunable filter allows light to be transmitted for wavelengths within a region where the peak spectral transmittances of the two Fabry-Perot cavities overlap in terms of wavelength, such as near 1140 nm as shown in FIG. 15(a). Thus, by independently controlling the etalons having different transmittance properties, any property suitable for its use can be obtained. This example also serves to improve the resolution in terms of wavelength.

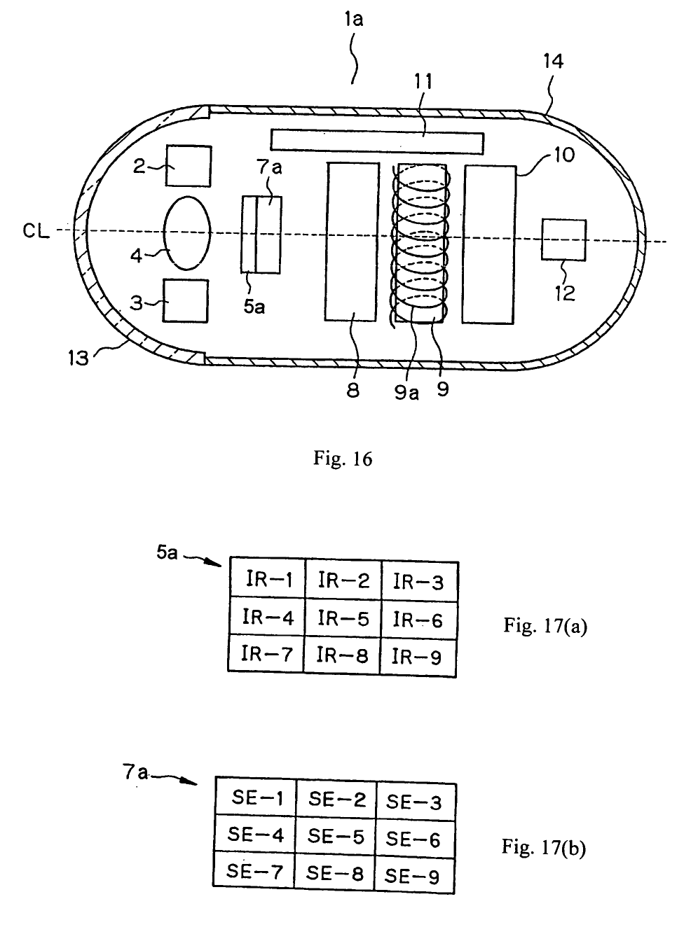

FIG. 16 illustrates a capsule optical sensor 1a as another embodiment of the present invention. The same reference numbers are given to the corresponding components in FIG. 1. The embodiment in FIG. 1 uses a tunable filter for scanning wavelengths to separate fluorescent wavelengths and detect fluorescence. The embodiment in FIG. 16 does not use a tunable filter. Instead, it uses plural filters having a previously fixed property consisting of multi-layered membranes each transmitting or reflecting a certain different wavelength to separate fluorescent wavelengths and detect fluorescence. FIG. 16 shows a filter 5a and a sensor array 7a consisting of several tens of arrayed photoelectric detection elements.

FIG. 17(a) is a front view of the filter 5a (i.e., viewed in the direction of the optical axis CL). The filter 5a has a rectangular shape overall and is formed of a total of nine, three in each row, band pass filters IR-1 to IR-9 having different spectroscopic properties. FIG. 17(b) is a front view of the sensor array 7a (i.e., viewed in the direction of the optical axis CL). The sensor array 7a also has a rectangular shape as a whole and consists of a total of nine, three in each row, photoelectric detection elements SE-1 to SE-9. As viewed from an object to be examined, the filter 5a is symmetrically placed in front of the sensor array 7a. In directions parallel to the optical axis CL, the photoelectric detection elements SE-1 to SE-9 and the band pass filters IR-1 to IR-9 are arranged with their corresponding numbers aligned.

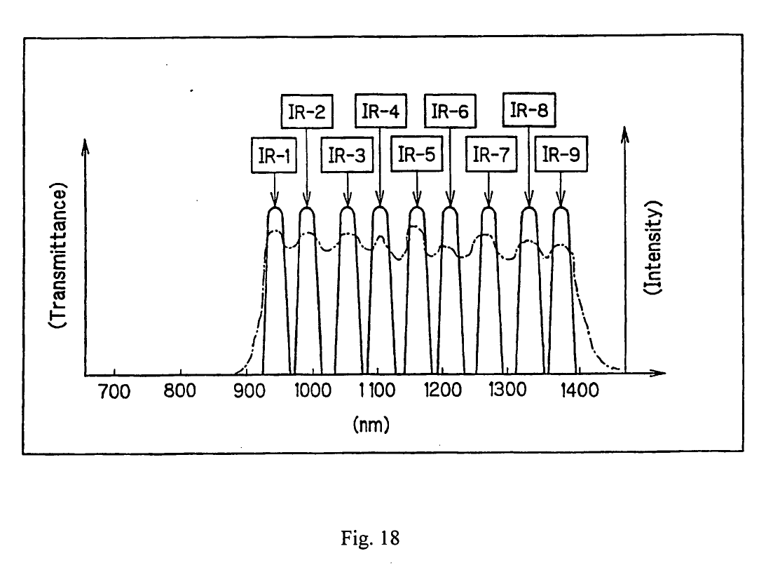

FIG. 18 shows spectroscopic properties of the filter 5a shown in FIG. 17(a). The solid line in this figure is a plot of the transmittance of the filter 5a as a function of wavelength. As shown in FIG. 18, the filter 5a transmits 9 different fluorescent emissions in the infrared region of the spectrum, labeled as IR-1 to IR-9. The broken line indicates fluorescence emitted by abnormal living tissue with attached quantum dots. The band pass filters IR-1 to IR-9 shown in FIG. 17(a) thus operate to separate and transmit these fluorescent signals.

The photoelectric detection elements SE-1 to SE-9 shown in FIG. 17(b) receive light that is separated and transmitted by the band pass filters IR-1 to IR-9. In this way, the photoelectric detection element SE-1 detects one fluorescent emission among plural fluorescent emissions. The photoelectric detection element SE-9 detects another, different, fluorescent emission. In this manner, the sensor array 7a shown in FIG. 17(b) detects nine different fluorescent labels having nine different peak transmission wavelengths.

As described above, with the structure as shown in FIGS. 16, 17(a), 17(b) and 18, nine different fluorescent emission spectra are separated and simultaneously detected. Thus, in this embodiment, the driven part of the tunable filter 6 shown in FIG. 1 is not required. Therefore, a simpler structure can be used. The filter shown in FIG. 16 also blocks excitation light that is emitted by the light emitting elements 2, 3. In the embodiment, a control circuit 8 that is similar to the control circuit 8 shown in FIGS. 1 and 2 is used, but the circuitry of the control circuit is simplified in that the filter control circuit 28 shown in FIG. 2 is eliminated.

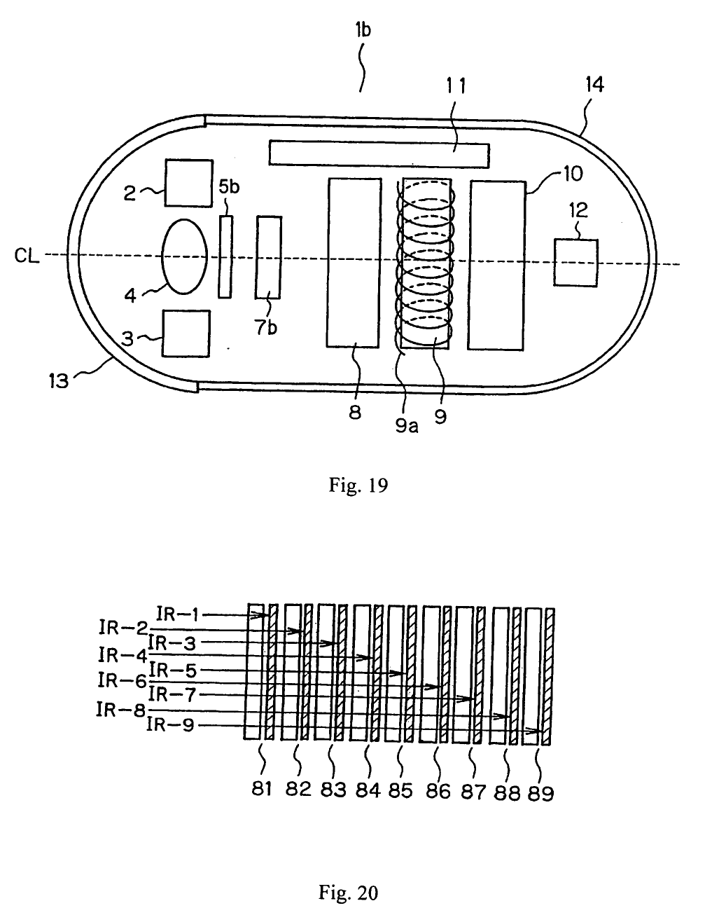

FIG. 19 shows the structure of another embodiment of the capsule optical sensor 1b of the present invention. Identical items to those shown in FIG. 1 have been labeled with the same reference numerals as in FIG. 1 and will not be further discussed. A sensor 7b shown in FIG. 19 is formed of photoelectric detection surfaces arranged in series along the optical axis, with each surface being absorptive of different wavelength ranges. The sensor of this embodiment is therefore able to separately detect plural fluorescent wavelength emissions. A filter 5b that blocks the excitation light and transmits the infrared light is provided in front of the sensor 7b.

FIG. 20 is a cross section of the sensor 7b shown in FIG. 19 as viewed from the side. As shown in FIG. 20, the sensor has nine light receiving layers 81-89 arranged in series along the optical axis. Each light receiving layer separately detects a different narrow wavelength band among the narrow wavelength bands IR-1 to IR-9 and other wavelength bands that are incident on a given receiving layer being predominantly transmitted. For example, a light receiving layer of the light receiving part 85 detects the wavelength band IR-5 shown in FIG. 18 and transmits other wavelengths. Sensors having such properties have already been developed, and thus further detailed discussion here will be omitted.

Alternatively, the sensor 7b can be formed of light receiving layers that are sensitive to incident light over broader wavelength ranges but that transmit the incident light at different ratios depending on the wavelength of the incident light, and with layers that prevent the transmission of specific fluorescent wavelengths positioned between the light receiving layers. For example, the different light receiving layers may block a respective one of the narrow wavelength bands IR-2 to IR-9 and the signals detected by the light receiving layers then processed so as to separately detect the different wavelength bands IR-1 to IR-9.

The sensor 7b in FIG. 20 uses a similar system to a VPS (variable pixel size) system in which data of several pixels are collectively read. VPS is one of the techniques for reading color signals in a color image sensor in which three photo detectors (i.e., light receiving layers) are arranged in the depth direction in silicon and one pixel is used to obtain RGB color signals.

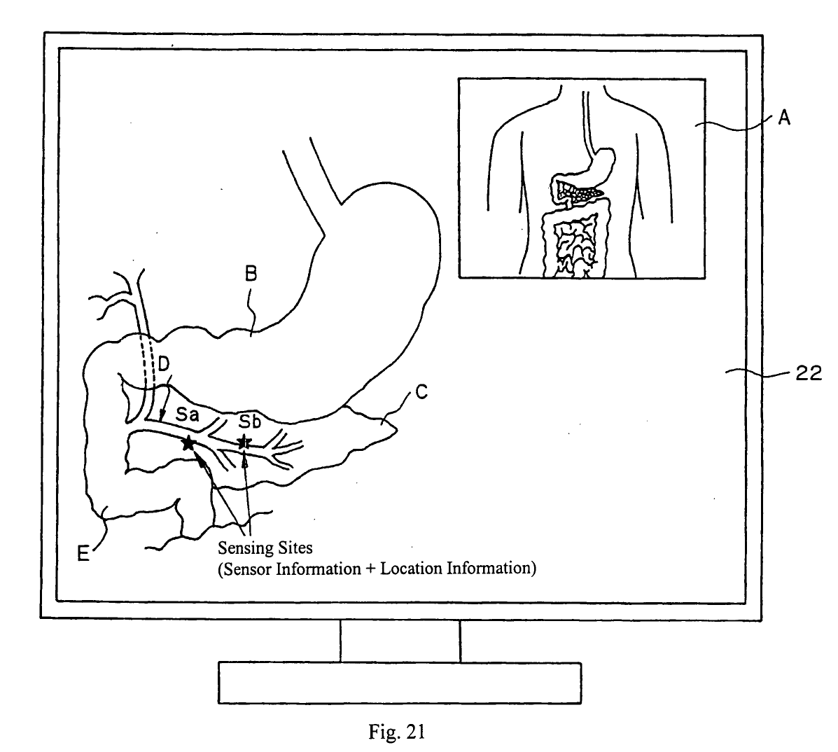

FIG. 21 is an illustration to show an image displayed on the monitor 22 of the external unit. As shown in FIG. 21, an overall image of entire organs of a patient that has previously been obtained by X-ray or CT is displayed in an area A at the top right corner of a display, such as a monitor screen. An enlarged image of portions visible in the region A is displayed on the remaining portion of the display. For example, in FIG. 21, the stomach B, the pancreas C, a pancreatic duct D, and the duodenum E are shown.

The fluorescence and location information obtained from the transmissions of the capsule optical sensor is merged and displayed as indicated by Sa and Sb. Sa and Sb can be displayed in different colors depending on obtained fluorescent labels; for example Sa in yellow, Sb in red. This allows for advanced diagnosis. The capsule optical sensor of the present invention uses a significantly smaller number, 20 at most, of photoelectric detection elements. This allows the outer diameter of the capsule of the capsule optical sensor to be as small as approximately 1 to several millimeters, which is significantly smaller than a conventional capsule endoscope.

Hence, the capsule optical sensor of the present invention can be introduced into a fine duct such as pancreatic duct D. This enables the fluorescent emissions of the fluorescent labels to be separately detected at sites such as Sa and Sb where detection using a capsule endoscope as in the prior art was not possible. Moreover, the position of the capsule optical sensor of the present invention can be determined without difficulty by tracing the direction of movement within the subject duct.

Information necessary for locating the position of a lesion is obtained from the location information of the capsule optical sensor. Combined with the organ morphology information from a CT, an image may be displayed on a monitor as shown in FIG. 21. Unlike a conventional capsule endoscope, the capsule optical sensor of the present invention is suitable for examining small ducts, such as in the pancreas and in blood vessels. When positioned within such small ducts, the outer diameter of the capsule optical sensor is nearly equal to the inner diameter of a subject duct; thus, the direction of movement of the capsule optical sensor of the present invention is usually limited to a single direction. Likewise, positional control is limited to movement in one direction (i.e., the direction of movement in the duct). Because the orientation of the capsule optical sensor is not needed, due to the orientation being defined by the orientation of the fine duct in which the capsule optical sensor is positioned, information is not really needed concerning the orientation of the capsule optical sensor. Thus, the structure of the capsule optical sensor can be simplified as compared to the structure of a capsule endoscope.

The present invention realizes advanced diagnosis using a capsule optical sensor. Moreover quantum dots allow more than one hour of observation time due to their emissions being bright and relatively prolonged. Because the excitation light is substantially limited to that of infrared light that penetrates deep inside living tissue, an infrared range band pass filter is not required on the light source side. Since the emission wavelengths of quantum dots have a narrow bandwidth, Gaussian distribution, the emissions may be detected using a Fabry-Perot, etalon-type, band pass filter.

In the present invention, the fluorescent wavelengths of quantum dots used as fluorescent labels have narrow bandwidth, Gaussian distributions. The peak wavelengths of these emissions can be adjusted by adjusting the material and outer diameters of the quantum dots, as shown in FIG. 23. For example, when InAs nanocrystals are used, the quantum dots may be formed with diameters in the range of 2.8 nm to 6.6 nm, such as diameters of 2.8, 3.6, 4.6, and 6.6 nm.

As described above, the present invention uses quantum dots such as ones made of InAs having plural different diameters that vary in the range from 2.8 to 6.6 nm. The quantum dots are synthesized to be hydrophilic and biocompatible. Moreover, the materials and outer diameters of the quantum dots can be optimized for the particular use, and the spectroscopic properties can be desirably specified for infrared excitation and infrared fluorescence.

Using quantum dots as described above, fluorescent labels (tags) are introduced into living tissue, illuminated with excitation light, and fluorescence in the near-infrared wavelength range is detected from the living tissue. This allows the detection of cancer in the earliest stage that develops deep inside the living tissue. The light source emits light having wavelengths in the infrared wavelength range from 600 to 2000 nm so as to excite the fluorescent labels. In this way, the present invention enables fluorescent labels that have been introduced into living tissue to be used to diagnosis cancer in its earliest stage.

As described above, the capsule optical sensor of the present invention uses one wavelength for excitation and multiple fluorescent emissions that are detected. It is characterized by the fact that plural target fluorescent emissions in the wavelength range from 600 to 2000 nm can be detected and the following items.

(1) The excitation wavelength range lies within the range from 600 to 2000 nm.

(2) There are plural observation (detection) wavelengths in the range above. The detected wavelengths are separated and scanned. In the embodiment of FIG. 1, the variable spectroscopic element is a Fabry-Perot filter, where the spacing within an air cavity between reflective surfaces of the Fabry-Perot filter is changed.

(3) In order to detect lesions in living tissue, nanometer-size quantum dots are introduced to attach to target proteins in the living tissue. The quantum dots may be, for example, InAs nanocrystals having particle sizes in the approximate range from 2.8 to 6.6 nm.

The invention being thus described, it will be obvious that the same may be varied in many ways. For example, the light emitting elements are not restricted to LEDs and can be electro luminescent displays (ELDs), plasma display panels (PDPs), vacuum fluorescent displays (VFDs) and field emission displays (FEDs). The fluorescent labels are not restricted to quantum dots and can be substances that bind to cancer-specific proteins at the molecular level, are excited primarily by light having near-infrared wavelengths, and emit fluorescence in the near-infrared wavelength range. For example, the products of Molecular Probes, Inc., listed at the Internet website “http://www.probes.com/” sold under the registered trade names “ALEXA FLUOR 647” and “ALEXA FLUOR 680” can be used in the present invention. In order to down-size the capsule optical sensor, the illuminators (such as one or more LEDs) and the sensor such as one or more photoelectric detection elements can be separated. The manner of separation is not restricted to the one described above. In addition, whereas the transmission wavelength separation element described above is formed of three aligned translucent members, the transmission wavelength separation element can instead be formed of only two aligned translucent members. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

1. A capsule optical sensor comprising:
an illuminator that includes a light source that produces light of an arbitrary, narrow wavelength band within the range from 600 to 2000 nm;
a photoelectric detection element that serves as a sensor and does not perform an imaging function; and
a tunable spectroscopic element provided in front of the light receiving surface of the photoelectric detection element.

2. A capsule optical sensor comprising:
an illuminator that includes a light source that produces light of an arbitrary, narrow wavelength band within the range from 600 to 2000 nm;
from one to several tens of photoelectric detection elements that serve as a sensor and do not perform an imaging function; and
optical filters respectively provided in front of the light receiving surfaces of the photoelectric detection element(s); wherein
the optical filters transmit light of different wavelength bands.

3. A capsule optical sensor comprising:
an illuminator that includes a light source that produces light of an arbitrary, narrow wavelength band within the range from 600 to 2000 nm; and
a detector that has a photoelectric detection element which serves as a sensor and does not perform an imaging function, the photoelectric detection element being composed of a stack of light receiving layers, each detecting a different wavelength range of incident light.

4. A capsule optical sensor for examining a subject who has been administered plural fluorescent labels producing fluorescence of different wavelengths in the near-infrared range, comprising:
an illuminator that generates excitation light for exciting a plurality of fluorescent labels;
a tunable spectroscopic element for selectively transmitting the fluorescence produced by the plural fluorescent labels;
a photoelectric detection element for receiving the light transmitted through the tunable spectroscopic element; and
a transmitter for transmitting output signals of the photoelectric detection element outside the capsule; wherein
said photoelectric detection element serves as a sensor and does not perform an imaging function.

5. A capsule optical sensor for examining a subject who has been administered a number n of different fluorescent labels that each produce fluorescence of different wavelengths in the near-infrared range, comprising:
an illuminator that generates excitation light for exciting the fluorescent labels;
an detector that includes a number n of detecting elements for detecting the n different fluorescence emissions, each one of the detecting elements having an optical filter that transmits one of n different fluorescent light emissions produced by the fluorescent labels;
a photoelectric detection element that serves as a sensor and does not perform an imaging function and that receives the light transmitted through the optical filter; and
a transmitter for transmitting output signals of the detector outside the capsule.

6. A capsule optical sensor for examining a subject who has been administered a number n of different fluorescent labels, each of which produces a fluorescence emission different from the others and in the near-infrared wavelength range, comprising:
an illuminator that generates excitation light for exciting the fluorescent labels;
a photoelectric detection element that is composed of a stack of n light receiving layers, each being sensitive to the fluorescence of a specific wavelength range among the n different fluorescent light emissions produced by the fluorescent labels; and
a transmitter for transmitting output signals of the photoelectric detection element outside the capsule; wherein
said photoelectric detection element serves as a sensor and does not perform an imaging function.

7. A capsule optical sensor according to claim 4, wherein the illuminator has a light source that produces light of an arbitrary narrow wavelength band within the range from 600 nm to 2000 nm.

8. A capsule optical sensor according to claim 5, wherein the illuminator has a light source that produces light of an arbitrary narrow wavelength band within the range from 600 nm to 2000 nm.

9. A capsule optical sensor according to claim 6, wherein the illuminator has a light source that produces light of an arbitrary narrow wavelength band within the range from 600 nm to 2000 nm.
